(19) United States
(12) Patent Application Publication
(10) Pub. No.: US 2025/0391852 A1
(43) Pub. Date: Dec. 25, 2025

(54) BATTERY

(71) Applicant: TOYOTA JIDOSHA KABUSHIKI KAISHA, Toyota-shi (JP)

(72) Inventor: Takuya MATSUYAMA, Miyoshi-shi (JP)

(73) Assignee: TOYOTA JIDOSHA KABUSHIKI KAISHA, Toyota-shi (JP)

(21) Appl. No.: 19/071,223

(22) Filed: Mar. 5, 2025

(30) Foreign Application Priority Data
Jun. 21, 2024 (JP) 2024-100550

(51) Int. Cl. H01M 4/38; H01M 4/04; H01M 4/137; H01M 4/66; H01M 10/0562

(52) U.S. Cl. CPC H01M 4/386; H01M 4/137; H01M 4/661; H01M 10/0562; H01M 4/043

(57) ABSTRACT

A battery including an electrode assembly including a positive electrode current collector, a positive electrode active material layer, a solid electrolyte layer, a negative electrode active material layer, and a negative electrode current collector that are stacked, in which the electrode assembly has a spring constant in a stacking direction of 27,000 kN/cm or less.

### CROSS-REFERENCE TO RELATED APPLICATION

This application claims priority to Japanese Patent Application No. 2024-100550 filed on Jun. 21, 2024, incorporated herein by reference in its entirety.

### BACKGROUND

### 1. Technical Field

The present disclosure relates to a battery.

### 2. Description of Related Art

Japanese Unexamined Patent Application Publication No. 2022-108509 (JP 2022-108509 A) discloses that a power generation element of an all-solid-state battery is surrounded and covered with an elastic member having a Young's modulus lower than that of a solid electrolyte so that expansion or contraction at the time of charging or discharging is absorbed.

### SUMMARY

However, when the elastic member is used as described above, the elastic member occupies a part of the battery, and thus the volume of the battery element is reduced by an amount corresponding to this part, resulting in that the energy density is reduced.

In view of the above, the present disclosure has an object to provide a battery capable of preventing the energy density from being reduced.

The present application discloses a battery including an electrode assembly including a positive electrode current collector, a positive electrode active material layer, a solid electrolyte layer, a negative electrode active material layer, and a negative electrode current collector that are stacked, in which the electrode assembly has a spring constant in a stacking direction of 27,000 kN/cm or less.

The negative electrode active material layer may have a filling factor of 80% or less.

An active material of the negative electrode active material layer may be Si, and may be particles obtained by covering the Si with a binding material included in the negative electrode active material layer.

An active material of the negative electrode active material layer may be an Si alloy, the Si alloy may be a porous material, and a volume of a pore of the porous material may be 0.3 mL/g.

A solid electrolyte included in the solid electrolyte layer may be a sulfide or an organic polymer.

The negative electrode current collector may be an aluminum foil.

With the battery of the present disclosure, it is possible to reduce a ratio occupied by the elastic member with respect to the total volume of the battery, and it is possible to prevent reduction in energy density of the battery due to the elastic member occupying the battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view illustrating a layer configuration of an all-solid-state battery; and

FIG. 2 is an explanatory view illustrating measurement of a spring constant of an electrode assembly.

### DETAILED DESCRIPTION OF EMBODIMENTS

### 1. CONFIGURATION OF BATTERY

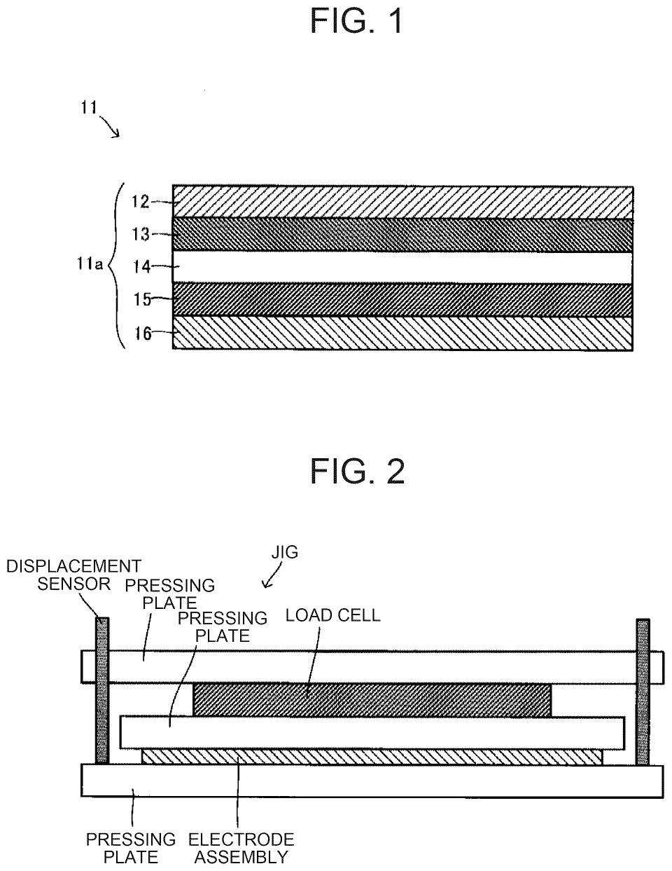

FIG. 1 is an explanatory view illustrating a solid-state battery (all-solid-state battery) according to one embodiment. In this case, an all-solid-state battery is described as one typical example, but the present disclosure is not always required to be the all-solid-state battery, and is applicable also to any battery including an electrode assembly and an outer casing that seals the electrode assembly (for example, a solid-state battery (a semi-solid-state battery) including a solid electrolyte and a liquid electrolyte). FIG. 1 illustrates a layer configuration of, within the solid-state battery, an electrode assembly 11 included in the solid-state battery. The solid-state battery is formed as the solid-state battery when such an electrode assembly 11 is sealed with the outer casing. For example, the electrode assembly 11 having substantially a rectangular shape in plan view is included in the outer casing having substantially a rectangular shape in plan view. At this time, a positive electrode terminal extends from a positive electrode current collector of the electrode assembly 11 and a negative electrode terminal extends from a negative electrode current collector of the electrode assembly 11, and the positive and negative electrode terminals are disposed so that leading ends thereof protrude from the outer casing.

In the following, components of the electrode assembly 11 and the relationship of the components are described in more detail.

The electrode assembly 11 includes a positive electrode current collector 12, a positive electrode active material layer 13, a solid electrolyte layer 14, a negative electrode active material layer 15, and a negative electrode current collector 16. In this embodiment, the positive electrode current collector 12, the positive electrode active material layer 13, the solid electrolyte layer 14, the negative electrode active material layer 15, and the negative electrode current collector 16 are stacked in the stated order to configure a unit element 11a, and a plurality of the unit elements 11a is stacked to configure the electrode assembly 11 (FIG. 1 illustrates only one unit element 11a.). Further, as described above, the positive electrode terminal is electrically connected to the positive electrode current collector 12 of the electrode assembly 11, and the negative electrode terminal is electrically connected to the negative electrode current collector 16 of the electrode assembly 11.

### 1.1. Positive Electrode Current Collector

The positive electrode current collector 12 is stacked on the positive electrode active material layer 13 to collect current from the positive electrode active material layer 13. In this embodiment, the positive electrode current collector 12 has a quadrangular foil shape in plan view, and can be configured of a positive electrode current collecting foil that is a metal foil, and an electrically conductive resin layer or a carbon layer stacked on the positive electrode current collecting foil. The positive electrode current collector 12 is stacked on the positive electrode active material layer 13 by stacking the electrically conductive resin layer or the carbon layer on the positive electrode active material layer 13.

As materials configuring the positive electrode current collector, examples of the material of the metal foil include stainless steel, aluminum, nickel, iron, and titanium. The electrically conductive resin layer can be configured of a resin in which an electrically conductive material is dispersed, and the carbon layer can be configured of a material including carbon.

### 1.2. Positive Electrode Active Material Layer

The positive electrode active material layer 13 has the positive electrode current collector 12 stacked on one surface thereof and the solid electrolyte layer 14 stacked on the other surface thereof. In this embodiment, the positive electrode active material layer 13 has a quadrangular sheet shape in plan view.

The positive electrode active material layer 13 is a layer containing a positive electrode active material, and may further contain at least one of a solid electrolyte material, an electrically conductive material, and a binding material as required.

The positive electrode active material may use a publicly-known active material. Examples of the active material include cobalt-based materials (such as LiCoO₂), nickel-based materials (such as LiNiO₂), manganese-based materials (such as LiMn₂O₄ and Li₂Mn₂O₃), iron phosphate-based materials (such as LiFePO₄ and Li₂FeP₂O₇), NCA-based materials (a compound of nickel, cobalt, and aluminum), and NMC-based materials (a compound of nickel, manganese, and cobalt). More specifically, LiNi_{1/3}Co_{1/3}Mn_{1/3}O₂ or the like may be used.

The surface of the positive electrode active material may be covered with an oxide layer such as a lithium niobate layer, a lithium titanate layer, or a lithium phosphate layer.

Further, as others, the positive electrode active material is not limited to the above-mentioned oxide-based material, and may be a sulfide-based material (a lithium titanium sulfide or a lithium niobium sulfide).

Examples of the solid electrolyte include an inorganic solid electrolyte. The inorganic solid electrolyte has a higher ion conductivity as compared with an organic polymer electrolyte, and is excellent in heat resistance. Examples of the inorganic solid electrolyte include a sulfide solid electrolyte and an oxide solid electrolyte.

Examples of the sulfide solid electrolyte material having a Li ion conductivity include Li₂S—P₂S₅, Li₂S—P₂S₅—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZmSn (where m and n are positive numbers, and Z is any one of Ge, Zn, and Ga), Li₂S—GeS₂, Li₂S—SiS₂—Li₃PO₄, and Li₂S—SiS₂—LiₓMO_{y} (where x and y are positive numbers, and M is any one of P, Si, Ge, B, Al, Ga, and In). It is to be noted that the description of “Li₂S—P₂S₅” above means a sulfide solid electrolyte material configured with the use of a raw material composition including Li₂S and P₂S₅, and the same holds true in other descriptions.

It is to be noted that, from the viewpoint of reducing the spring constant of the present disclosure, a sulfide solid electrolyte is more preferable than an oxide solid electrolyte.

Meanwhile, examples of the oxide solid electrolyte material having the Li ion conductivity include a compound having an NASICON-type structure. Examples of the compound having the NASICON-type structure include a compound (LAGP) expressed by a general formula Li₁₊ₓAlxGe₂₋ₓ(PO₄)₃ (0≤x≤2) and a compound (LATP) expressed by a general formula Li₁₊ₓAlₓTi₂₋ₓ(PO₄)₃ (0≤x≤2). Further, other examples of the oxide solid electrolyte materials include LiLaTiO (for example, Li_{0.34}La_{0.51}TiO₃), LiPON (for example, Li_{2.9}PO_{3.3}N_{0.46}), and LiLaZrO (for example, Li₇La₃Zr₂O₁₂).

It is to be noted that, from the viewpoint of reducing the spring constant of the present disclosure, an organic polymer electrolyte may be used. As another example, the above-mentioned inorganic solid electrolyte and the organic polymer electrolyte may be used together.

The polymer electrolyte at least contains a polymer component. Examples of the polymer component include a polyether-based polymer, a polyester-based polymer, a polyamine-based polymer, and a polysulfide-based polymer. Among them, a polyether-based polymer is preferable. The reason therefor is because the polyether-based polymer has a high ion conductivity and is excellent in mechanical characteristics such as the Young's modulus and the rupture strength.

The polyether-based polymer includes a polyether structure in a repeating unit. Further, the polyether-based polymer preferably includes the polyether structure in a main chain of the repeating unit. Examples of the polyether structure include a polyethylene oxide (PEO) structure and a polypropylene oxide (PPO) structure. The polyether-based polymer preferably includes the PEO structure as a main repeating unit. The proportion of the PEO structure with respect to all the repeating units in the polyether-based polymer is, for example, 50 mol % or more, and may be 70 mol % or more or 90 mol % or more. Further, the polyether-based polymer may be, for example, a homopolymer or a copolymer of an epoxy compound (such as an ethylene oxide or a propylene oxide).

The polymer component may include an ion conductive unit as described below. Examples of the ion conductive unit include polyethylene oxide, polypropylene oxide, polymethacrylic acid ester, polyacrylic acid ester, polydimethylsiloxane, polyacrylic acid, polymethacrylic acid, polyethylene vinyl acetate, polyimide, polyamine, polyamide, polyalkyl carbonate, polynitrile, polyphosphazene, polyolefin, and polydiene.

The weight-average molecular weight (Mw) of the polymer component is not particularly limited, but is, for example, 1,000,000 or more and 10,000,000 or less. Mw is obtained by gel permeation chromatography (GPC). Further, the glass transfer temperature (Tg) of the polymer component is, for example, 60° C. or less, and may be 40° C. or less or 25° C. or less. Further, the polymer electrolyte may contain only one kind of the polymer component, or may contain two kinds or more of the polymer component. Further, the polymer electrolyte may be a crosslinked polymer electrolyte to which the polymer component is crosslinked, or may be a non-crosslinked polymer electrolyte to which no polymer component is cross-linked.

The polymer electrolyte may be a dry polymer electrolyte or may be a gel

electrolyte. The dry polymer electrolyte refers to an electrolyte of which content of the solvent component is 5% by weight or less. The content of the solvent component may be 3% by weight or less, or may be 1% by weight or less. It is to be noted that, when a sulfide solid electrolyte having a high reactivity to a polar solvent is used as the positive electrode active material layer, the dry polymer electrolyte is preferably used.

The dry polymer electrolyte may contain a supporting salt. Examples of the supporting salt include inorganic lithium salts such as LiPF₆, LiBF₄, LiClO₄, and LiAsF₆ and organic lithium salts such as LiCF₃SO₃, LiN(CF₃SO₂)₂, LiN(C2F5SO₂)₂, LiN(FSO₂)₂, and LiC(CF₃SO₂)₃. The proportion of the supporting salt with respect to the dry polymer electrolyte is not particularly limited. For example, when the dry polymer electrolyte includes an EO unit (C₂H₅O unit), the EO unit with respect to 1 part by mole of the supporting salt is, for example, 5 parts by mole or more, and may be 10 parts by mole or more or 15 parts by mole or more. Meanwhile, the EO unit with respect to 1 part by mole of the supporting salt is, for example, 40 parts by mole or less, and may be 30 parts by mole or less.

The gel electrolyte normally contains a liquid electrolyte component in addition to the polymer component. The liquid electrolyte component contains a supporting salt and a solvent. The supporting salt is similar to that described above. Examples of the solvent include carbonate. Examples of the carbonate include: cyclic esters (cyclic carbonate) such as ethylene carbonate (EC), propylene carbonate (PC), and butylene carbonate (BC); and chain esters (chain carbonate) such as dimethyl carbonate (DMC), diethyl carbonate (DEC), and ethyl methyl carbonate (EMC). Further, examples of the solvent include acetates such as methyl acetate and ethyl acetate, and ether such as 2-methyltetrahydrofuran. Moreover, examples of the solvent include γ-butyrolactone, sulfolane, N-methylpyrrolidone (NMP), and 1,3-dimethyl-2-imidazolidinone (DMI). Further, the solvent may be water.

The binding material is not particularly limited as long as the binding material is chemically and electrically stable. Examples of the binding material include fluorine-based binding materials such as polyvinylidene fluoride (PVDF) and polytetrafluoroethylene (PTFE), rubber-based binding materials such as styrene-butadiene rubber (SBR), olefin-based binding materials such as polypropylene (PP) and polyethylene (PE), and cellulose-based binding materials such as carboxymethyl cellulose (CMC).

As the electrically conductive material, carbon materials such as acetylene black (AB), Ketjenblack, and carbon fibers, or metal materials such as nickel, aluminum, and stainless steel can be used.

The content of each component in the positive electrode active material layer 13 may be similar to that in the related art. Further, the thickness of the positive electrode active material layer 13 is, for example, preferably 0.1 μm or more and 1 mm or less, more preferably 1 μm or more and 150 μm or less.

### 1.3. Solid Electrolyte Layer

The solid electrolyte layer (separator layer) 14 has a quadrangular sheet shape in plan view in this embodiment, and is a layer disposed between the positive electrode active material layer 13 and the negative electrode active material layer 15 and including a solid electrolyte material. The solid electrolyte layer 14 at least contains the solid electrolyte material. The solid electrolyte material can be considered similarly to the solid electrolyte material described for the positive electrode active material layer 13.

### 1.4. Negative Electrode Active Material Layer

The negative electrode active material layer 15 is a layer at least containing a negative electrode active material. The negative electrode active material layer 15 may include a binding material, an electrically conductive material, and a solid electrolyte material as required. The binding material, the electrically conductive material, and the solid electrolyte material can be considered similarly to those of the positive electrode active material layer 13.

The negative electrode active material is not particularly limited, but, when a lithium ion battery is configured, examples of the negative electrode active material include carbon materials such as graphite and hard carbon, various oxides such as lithium titanate, Si and an Si alloy, and a lithium metal and a lithium alloy.

The negative electrode active material layer 15 has a quadrangular sheet shape in plan view in this embodiment, and has the solid electrolyte layer 14 stacked on one surface thereof and the negative electrode current collector 16 stacked on the other surface thereof.

The content of each component in the negative electrode active material layer 15 may be similar to that in the related art. Further, the thickness of the negative electrode active material layer 15 is, for example, preferably 0.1 μm or more and 1 mm or less, more preferably 1 μm or more and 150 μm or less.

### 1.5. Negative Electrode Current Collector

The negative electrode current collector 16 is stacked on the negative electrode active material layer 15 to collect current from the negative electrode active material layer 15. In this embodiment, the negative electrode current collector 16 has a quadrangular foil shape in plan view, and can be configured of, for example, stainless steel, copper, nickel, carbon, or aluminum.

### 1.6. Positive Electrode Terminal and Negative Electrode Terminal

The positive electrode terminal and the negative electrode terminal are members having electrical conductivity, and become terminals for electrically connecting the electrodes to the outside.

The positive electrode terminal has a first end electrically connected to the positive electrode current collector 12, and a second end passing through the outer casing so as to be exposed to the outside.

The negative electrode terminal has a first end electrically connected to the negative electrode current collector 16, and a second end passing through the outer casing so as to be exposed to the outside.

### 1.7. Outer Casing

The outer casing is configured of a rectangular sheet-shaped member in plan view, and includes, for example, a first sheet and a second sheet. The electrode assembly 11 is included between the first sheet and the second sheet, and an outer peripheral end portion of the first sheet and an outer peripheral end portion of the second sheet are joined so as to be sealed. Thus, the outer casing has a bag shape, and the electrode assembly 11 is included and sealed therein.

The first sheet and the second sheet can each be configured of a laminated film. Here, the laminated film refers to a film including a metal layer and a sealant material layer. Examples of the metal or the like used in the laminated film include aluminum and stainless steel, and examples of the material used in the sealant material layer include polypropylene, polyethylene, polystyrene, and polyvinyl chloride which are thermoplastic resins.

### 1.8. Spring Constant of Electrode Assembly

The electrode assembly 11 including the stacked layers described above has a spring constant in the stacking direction in the unit element 11a of 27,000 kN/cm or less. In this manner, the electrode assembly 11 can be easily elastically deformed and can absorb the expansion or contraction caused at the time of charging or discharging of the battery. Thus, the use of the elastic member may be eliminated, or the amount of the elastic member can be reduced even when the elastic member is added to the electrode assembly 11. In addition, the occupancy ratio of the elastic member to the volume of the battery can be decreased, and thus a larger amount of battery elements (unit elements) can be disposed in this space, resulting in that the energy density of the battery can be enhanced. The value of the spring constant in the stacking direction of the unit element 1la can be obtained as described in Examples later.

The spring constant is only required to be 27,000 kN/cm or less, but, as the spring constant is smaller, the occupancy ratio of the elastic member can be reduced and the energy density can be enhanced. Accordingly, the spring constant is preferably 25,000 kN/cm or less, more preferably 22,000 kN/cm or less. It is to be noted that the lower limit of the spring constant is not particularly limited, but is preferably 8,000 kN/cm. When the spring constant is lower than 8,000 kN/cm, it may be difficult to configure the solid-state battery. The spring constant is more preferably 11,000 kN/cm or more.

The adjustment of the spring constant of the electrode assembly is not particularly limited, but examples thereof include measures of [Aspect 1] to [Aspect 5] described below. Any of those aspects, a combination of a plurality of the aspects, or further another aspect may be used.

### Aspect 1

At the time of stacking the layers described above, pressing is normally performed while the temperature is increased, but, in order to adjust the spring constant, the pressing and stacking are performed at normal temperature or a temperature lower than usual. In this manner, an air gap is liable to be generated in the electrode assembly, and the spring constant can be kept low.

For example, in this manner, the porosity in the negative electrode active material layer may be 20% or more (the filling factor of 80% or less), and the spring constant can be kept low. It is to be noted that, from the viewpoint of performance of the battery, the filling factor of the positive electrode active material layer is preferably 80% or more.

It is to be noted that, instead of setting the temperature to normal temperature or a temperature lower than usual or in addition thereto, a pressing pressure can be decreased than usual so that the spring constant is kept low.

### Aspect 2

When Si is used as the negative electrode active material, a material (granulated material) obtained by covering the Si with a binding material (binder) is used. Even in this case, the spring constant of the electrode assembly 11 can be kept low. The reason therefor is considered to be because the air gap between the Si surface and the covering layer contributes to the decrease of the spring constant.

### Aspect 3

When an Si alloy is used as the negative electrode active material, the spring constant can be kept low by using the Si alloy being a porous material. The specific volume of the pore is preferably 0.3 mL/g or more.

### Aspect 4

The spring constant of the electrode assembly can be reduced by using a material having a low elastic modulus (Young's modulus) for the negative electrode current collector 16. For example, the negative electrode current collector normally using a nickel foil is changed to an aluminum foil. In this manner, the spring constant can be kept low even as the entire electrode assembly 11.

### Aspect 5

When the solid electrolyte in the solid electrolyte layer is changed to a sulfide solid electrolyte or an organic polymer electrolyte, the spring constant can be kept low as compared with the oxide solid electrolyte.

### 2. EXAMPLES

In Examples, tests were performed with the spring constant in the stacking direction of the electrode assembly being changed.

### 2.1. Production of Electrode Assembly Shaping of Positive Electrode Active Material Layer

The positive electrode active material layer was obtained by weighing the positive electrode active material, the sulfide solid electrolyte, the electrically conductive material, and the binder to be, in a mass ratio, (positive electrode active material):(sulfide solid electrolyte):(electrically conductive material):(binder)=85:13:1.3:0.7 and shaping the materials.

In this case, for the positive electrode active material, a material obtained by coating NCA (produced by Sumitomo Metal Mining Co., Ltd.) with an oxide was used. For the sulfide solid electrolyte, a material obtained by synthesizing 10LiI-90 (0.75Li₂S—0.25P₂S₅) and crystallizing and micronizing the result was used. For the electrically conductive material, a vapor grown carbon fiber (VGCF, produced by Showa Denko K.K.) was used. The binder was PVDF.

### Shaping of Solid Electrolyte Layer

The sulfide solid electrolyte and the binder similar to those of the positive electrode active material layer were mixed to become 99.6:0.4 in a mass ratio so that a solid electrolyte mixed material was obtained. The obtained solid electrolyte mixed material was shaped so that a solid electrolyte layer (having a thickness of 15 μm) was obtained.

### Shaping of Negative Electrode Active Material Layer

The negative electrode active material layer was obtained by weighing the negative electrode active material, the sulfide solid electrolyte, the electrically conductive material, and the binder to be, in a mass ratio, (negative electrode active material):(sulfide solid electrolyte):(electrically conductive material):(binder)=53:41:4.5:1.5 and shaping the materials. It is to be noted that, for the negative electrode active material, Si (produced by Mitsui Kinzoku Company, Limited., having an average particle size D50=2.5 μm) was used. The sulfide solid electrolyte, the electrically conductive material, and the binder are similar to those used in the positive electrode active material layer.

In this case, the average particle size D50 is a value of a volume-based median diameter measured by laser diffraction/scattering particle size distribution measurement. Further, the median diameter (D50) is a diameter (volume average diameter) at which, when particles are arranged in ascending order of their particle diameter, the accumulated volume of the particles is half (50%) the total volume of the particles.

### Preparation of Current Collectors

As the positive electrode current collector, a stack of a metal foil (aluminum, having a thickness of 12 μm) and an electrically conductive resin (an acryl-based resin, having a thickness of 2 μm) was prepared. As the negative electrode current collector, a nickel (Ni) foil (having a thickness of 10 μm) was prepared.

### Production of Solid-State Battery

The layers described above were stacked so that an electrode assembly (of a comparative example) that became a reference was obtained. The electrode assembly had a layer configuration of positive electrode current collector/positive electrode active material layer/solid electrolyte layer/negative electrode active material layer/negative electrode current collector. It is to be noted that the layers were stacked so that the electrically conductive resin of the positive electrode current collector was in contact with the positive electrode active material layer. Further, at the time of stacking, heat and pressure were applied at 170° C. and a pressing pressure of 11.2 MPa.

### Example 1

In Example 1, in order to adjust the spring constant in the stacking direction of the electrode assembly, the stacking of the layers was performed at normal temperature without performing heating.

### Example 2

In Example 2, in order to adjust the spring constant in the stacking direction of the electrode assembly, Si was used as the negative electrode active material, and a granulated material obtained by covering the Si particles with a binder was used.

### Example 3

In Example 3, in order to adjust the spring constant in the stacking direction of the electrode assembly, for the negative electrode current collector, a foil using aluminum (Al) in place of Ni was used.

### Example 4

In Example 4, in order to adjust the spring constant in the stacking direction of the electrode assembly, the pressing pressure was reduced than other examples.

### Example 5

In Example 5, in order to adjust the spring constant in the stacking direction of the electrode assembly, the pressing pressure was reduced than Example 4.

### 2.2. Measurement of Spring Constant

As illustrated in FIG. 2, the electrode assembly was disposed in a jig so as to be sandwiched between pressing plates, and was installed on an autograph (SHIMADZU CORPORATION, AG-X50kN). A displacement amount was obtained by a displacement sensor while a load is applied to the electrode assembly by the pressing plates. A force at this time was measured by a load cell, and the Young's modulus (the spring constant) was calculated from a relationship between stress and strain. At this time, the head speed of the autograph was set to 0.15 mm/min and a load range was set to 0 kN to 49 kN.

It is to be noted that, in Examples, the measurement was performed with the state of charge (SOC) of the battery being 0%.

In Examples, the spring constant was measured as described above by using an electrode assembly configured of one unit element, but the spring constant of the electrode assembly configured of a plurality of unit elements may be measured as described above and converted into a spring constant per unit element (it may be considered that the unit elements are connected in series.).

### 2.3. Results

An elastic member occupancy ratio and an energy density increase rate were calculated in addition to the spring constant.

The elastic member occupancy ratio was obtained by calculating the size of the elastic member additionally required to obtain a spring constant normally required as the entire battery from the spring constant obtained through measurement and expressing, by percentage, the ratio occupied by the elastic member with respect to the entire battery.

The energy density increase rate was obtained by calculating the electrical energy density at the time of charging or discharging of the battery and expressing, by percentage, an increase rate from the reference (comparative example) being regarded as 0.

Further, as “other performance as battery”, the charging/discharging performance is shown as a value of each example with reference to the comparative example being regarded as 100.

TABLE 1

| | Spring | Elastic member | Energy density | Other |
|---|---|---|---|---|
| | constant | occupancy | increase | performance |
| | (kN/cm) | ratio (%) | rate (%) | as battery |
| Comparative | 27190 | 16.8 | 0.0 | 100 |
| Example | | | | |
| Example 1 | 25600 | 10.4 | 7.7 | 100 |
| Example 2 | 21470 | 8.3 | 10.2 | 100 |
| Example 3 | 15740 | 4.1 | 15.3 | 100 |
| Example 4 | 11320 | 1.4 | 18.5 | 87 |
| Example 5 | 8360 | 0.1 | 20.8 | 32 |

As understood from the results, by keeping the spring constant low, the occupancy ratio of the elastic member can be reduced, and the energy density can be enhanced.

It is to be noted that Examples show results at the time when the SOC is 0%, but, even when the battery is in a charged state, results in a similar range can be obtained as the spring constant. For example, when the SOC is 50% in Example 3, the spring constant is 19,570 kN/cm, and Example 3 provides effects in a range similar to that when the SOC is 0%.

What is claimed is:

1. A battery comprising an electrode assembly including a positive electrode current collector, a positive electrode active material layer, a solid electrolyte layer, a negative electrode active material layer, and a negative electrode current collector that are stacked, wherein the electrode assembly has a spring constant in a stacking direction of 27,000 kN/cm or less.

2. The battery according to claim 1, wherein the negative electrode active material layer has a filling factor of 80% or less.

3. The battery according to claim 1, wherein an active material of the negative electrode active material layer is Si, and is particles obtained by covering the Si with a binding material included in the negative electrode active material layer.

4. The battery according to claim 1, wherein:
an active material of the negative electrode active material layer is an Si alloy;
the Si alloy is a porous material; and
a volume of a pore of the porous material is 0.3 mL/g.

5. The battery according to claim 1, wherein a solid electrolyte included in the solid electrolyte layer is a sulfide or an organic polymer.

6. The battery according to claim 1, wherein the negative electrode current collector is an aluminum foil.
